(19) United States
(12) Patent Application Publication
(10) Pub. No.: US 2026/0285030 A1
(43) Pub. Date: Sep. 24, 2026

(54) HIGH-DEFINITION PRINTING USING INDEPENDENTLY DEVELOPED AEROSOL AND SHEATH GAS FLOWS

(71) Applicant: Integrated Deposition Solutions, Inc., Albuquerque, NM (US)

(72) Inventors: Marcelino Essien, Albuquerque, NM (US); Stephen Barnes, Albuquerque, NM (US); Paul Carpenter, Albuquerque, NM (US)

(73) Assignee: Integrated Deposition Solutions, Inc., Albuquerque, NM (US)

(21) Appl. No.: 19/576,046

(22) Filed: Mar. 24, 2026

Related U.S. Application Data
(60) Provisional application No. 63/776,358, filed on Mar. 24, 2025.

(51) Int. Cl. B41J 2/03; B41J 2/175; B41J 29/377

(52) U.S. Cl. CPC B41J 2/03; B41J 2/17503; B41J 29/377; B41J 2002/031

(57) ABSTRACT

An apparatus for stable aerosol-based printing features on a surface includes an aerosolization source adapted to produce an aerosol from an ink. A cooler cools at least one of the ink or the substrate to between 0 and 30 20 C. An ink cartridge retains the ink and has an inclined channel. A compressed gas source is adapted to transport the aerosol. At least one aerodynamic lens has a lens gas sheath around the aerosol transiting therethrough. A dispense nozzle or a capillary has a dispense gas sheath around the aerosol and focusing the aerosol to a minimum deposited size of 1 micron or less. A process for printing 1-micron traces with 2-micron spacing for 24 hours includes producing an aerosol distribution with droplet diameters ranging from approximately 0.3 to 5 microns. An ultrasonic aerosolization excitation frequency operates in the range of 0.1 to 1.0 MHz and acts on the ink.

### RELATED APPLICATIONS

This application claims priority benefit of U.S. Provisional Application Ser. No. 63/776,358; filed Mar. 24, 2025; the contents of which are hereby incorporated by reference.

### GRANT INFORMATION

This Invention was made with U.S. Government support under an Agreement supported by an award by Air Force Research Laboratory (AFRL) with SEMI under Agreement

Number FA8650-20-2-5506 in support of Army Research Laboratory (ARL). The U.S. Government has certain rights in the Invention.

### FIELD OF THE INVENTION

The present invention in general relates to an aerosol printing apparatus and the use thereof and in particular, to the operation of the aerosol printing apparatus to create fine and ultrafine features on a substrate.

### BACKGROUND OF THE INVENTION

Direct Write printing, defined as maskless printing of discreet patterns on a substrate in a one-step process, offers many advantages over conventional printing technologies such as lithography and chemical and physical vapor deposition. Indeed, Direct Write processes such as aerosol-based printing are far less expensive to establish and maintain and offer greater flexibility than conventional techniques. Embodiments of the present invention offer a method and apparatus for aerosol-based direct printing of discreet patterns using a multi-lens aerodynamic focusing assembly and a non-contact shuttering assembly that is internal to the print head of the apparatus.

### DESCRIPTION OF THE PRIOR ART

Hydrodynamic focusing using a sheath gas is generally accomplished by propagating an annular sheath/aerosol flow through a continuously converging nozzle, using differing sheath and aerosol gas flow rates. The degree of focusing is proportional to the ratio of the gas flows. In U.S. Pat. No. 7,108,894B2, Renn discloses a method of particle focusing using a coaxial sheath gas flow that surrounds an aerosol-laden carrier gas. The combined flow is then propagated through a converging nozzle. Renn teaches that for the operational range of a flow system using a sheathed aerosol stream and a single converging nozzle, the diameter of the focused beam is a strong function of the ratio of the sheath to aerosol gas flow rates.

Many researchers have reported studies of aerodynamic focusing of aerosol streams using fixed multi-stage lens systems (Lee, Brockmann, and Lui). Lee discloses an aerodynamic lens for focusing nanoparticles with diameters ranging from 30 to 3000 nanometers. Brockmann describes a multi-stage lens system that focuses large, solid particles. The Brockmann apparatus also uses an annularly flowing sheath gas to prevent impaction of particles onto the orifice surfaces. The apparatus of Brockmann propagates a sheath gas flow through the entire multi-stage lens system. Lui has disclosed an apparatus for focusing nanoparticles using an aerodynamic system consisting of three to five stages.

The ability to focus a droplet entrained in a gas stream is related to the Stokes number, St, of the droplet. It is generally accepted that optimum focusing of an aerosol is obtained when St is equal to unity. In aerosol printing, unfocused droplets can generally be categorized as overspray or satellite deposition. Overspray deposition occurs when small droplets pass through an aerodynamic lens assembly or through a single nozzle or capillary orifice with a small Stokes number, never achieving a Stokes number near unity at any stage of the assembly. Conversely, satellite droplets are generated when large droplets pass through a single orifice or through successive stages of a lens assembly with Stokes number much greater than unity. The Stokes number is related to the particle diameter and the orifice diameter according to the equation;

$$St = ( ( ρ d \hat{} 2 C ) / 18 μ ) U / D$$

where r is the particle density, d the particle diameter, C the slip correction factor, the gas dynamic viscosity, U the gas velocity at the orifice, and D the orifice diameter. The slip correction factor is calculated to be approximately 1.

In aerosol printing, the energy difference between deposited coalesced droplet surface tension σd and the substrate surface energy σs must be maintained at an appropriate level. In the case where σs>>σd, uncontrolled ink spreading occurs. In the opposite extreme, where σd>>σs, wetting is inhibited, and poorly formed traces and poor adhesion result. For non-aqueous inks—generally inks with low surface tension—the energy difference between the droplet surface tension and the substrate surface is critical. In the case of aqueous inks with relatively high surface tension, care must be taken to raise the substrate energy so that ink dewetting does not occur. An optimum or near-optimum difference between droplet and surface energies can be produced by raising or lowering the energies in a controlled manner.

Generally, the occurrence of wetting or dewetting will depend on the contact angle formed between coalesced droplets, air, and substrate. A large contact angle will lead to excessive wetting and uncontrolled spreading, while a small contact angle may cause dewetting and poor adhesion.

At least three modes of ink/substrate wetting occur in aerosol deposition. The viability of each mode with respect to aerosol printing can be accessed by considering static deposition, where no substrate motion occurs, and coalesced droplets are allowed to accumulate under the printer nozzle. In all three modes, droplets from the aerosol stream impact the substrate and coalesce to form a liquid film that grows from a point under the exit orifice of the nozzle. The deposition mechanics associated with each mode depend on the difference between the droplet surface tension and the substrate surface energy. The energy difference determines the droplet contact angle. In mode 1, the energy of the surface is significantly greater than the droplet surface tension, and uncontrolled spreading occurs. In mode 2, the surface energies of the substrate and droplet are similar, and pooling occurs. In the pooling mode, and with a cylindrically symmetric aerosol jet, coalesced droplets form a circular film that spreads radially from the point under the nozzle orifice. In mode 3, the droplet surface energy is greater than the substrate energy, and sufficient to overcome the combined molecular surface forces and the gravitational force, so that fluid stacking occurs. In the fluid stacking mode, coalesced ink droplets form a fluid column that grows upwards toward the nozzle orifice. While pure fluid stacking is difficult to achieve, the apparatuses and methods described in this disclosure are designed to achieve aerosol deposition using a range of parameters that yield some fluid stacking. Defect-free printing occurs in a range of printing parameters where deposition begins in mode 3 and transitions to mode 2 as the deposited ink warms.

Thus, there exists a need for an aerosol printing apparatus and the operation thereof of overcome the aforementioned limitations of the prior art and to achieve fine and even ultrafine deposition printing. There further exists a need for such an apparatus to operate continually for several hours with consistent resolution.

### SUMMARY OF THE INVENTION

The present invention discloses the use of an aerosol printing method that uses an annular sheath flow surrounding a cooled aerosol stream composed of a narrow droplet diameter distribution. The diameter distribution of the invention (0.3 to 2 microns) is narrower than the normal diameter distribution (0.3 to 5 microns) produced using common 1.6 MHz ultrasonic aerosolization. The aerosol stream propagates through a series of aerodynamic lenses matched to the droplet diameter distribution. Furthermore, the energy difference between the droplet surface tension and the substrate surface energy is maintained so that fluid pinning and stacking is accomplished without substrate heating, enabling high-resolution, high-aspect ratio printing.

The current invention discloses a method for stable direct printing of high-definition, fine and ultra-fine traces using aerosol-based printing. Printed features can be deposited with trace widths as small as approximately 1 micron, with spacing as small as approximately 2 microns. The invention produces and maintains a distribution of micron-size aerosol droplets with diameters that are matched to a sheathed assembly of aerodynamic lenses. The lens assembly can focus a matched distribution to a minimum spot size of less than 1 micron, so that high-definition structures are printed without droplet defocusing. An aerosol can be produced from an ink using various aerosolization methods, however ultrasonic aerosolization is the preferred aerosolization method of the invention. The ink can be a nanoparticle suspension, a particle-free solution, a nanoparticle solution and particle-free ink combination, or a solute dissolved in a suitable solvent. Maintenance of the matched diameter distribution during transport from the aerosolization source to a focusing assembly is critical to printing high-definition traces, since droplet evaporation will result in detuning of the distribution. Maintenance of the droplet diameter distribution is accomplished by adding solvent vapor to the aerosol transport gas or to the sheath gas. In some cases, solvent vapor is added to the aerosol and sheath gas flows. Furthermore, while the addition of solvent vapor to the gas flows will improve print quality, the presence of small droplets in the aerosol stream will remain problematic. Since the addition of solvent vapor to the gas flows will also prevent large droplet evaporation, deposition of large droplets can become an issue. The addition of solvent vapor to the aerosol and sheath flows can also lead to solvent condensation as the gas propagates through parts of the printer that are at a lower temperature than the gas.

While the invention uses an aerodynamic lens assembly to focus a range of droplet diameters, a single-orifice system can be used to produce ultrafine, high-definition traces if the droplet diameter distribution is narrowed sufficiently.

The current invention produces fine and ultrafine printed traces using a sufficiently narrow aerosol droplet diameter distribution to form a focused aerosol beam diameter as small as approximately one micron, and by managing ink and substrate surface energy differences and thermodynamic perturbations that occur at the substrate surface. Fine traces are defined as traces with widths between approximately 15 and 50 microns. Ultrafine traces are defined as traces with widths less than 15 microns. The current invention can use any aerosolization method that produces a droplet distribution with droplet diameters in the range of approximately 0.3 to 5 microns. In such a distribution, the smallest droplets, in the range of approximately 0.3 to 1 micron, are easily focused with dispense nozzles large enough to provide stable, repeatable printing. The apparatus of the current invention uses gravitational settling to filter large droplets in the range of approximately 2 to 5 microns. The largest droplets remaining in the distribution are easily focused upstream of the dispense nozzle by large-diameter aerodynamic lenses, eliminating satellite droplet deposition.

The preferred embodiment of the invention operates without clogging and uses common fluid dispense nozzles with diameters (approximately 30 to 100 microns) that are smaller than those typically used for stable aerosol printing. The present invention also uses a cooled print head that allows for reduced ink solvent evaporation, and high-accuracy mass flow controllers that produce stable printing using low gas flow rates.

In some inventive embodiments, the substrate is also cooled to reduce or eliminate air flow at the substrate surface, preventing deposition of droplets outside the target print area.

### BRIEF DESCRIPTION OF THE DRAWINGS

The present invention is further detailed with respect to the following drawings that are intended to show certain aspects of the present of invention, but should not be construed as limit on the practice of the invention, wherein:

FIG. 1 is a cross-sectional view of a print head according to the present invention;

FIG. 2A is side view of the flow cell and aerodynamic lenses according to the present invention;

FIG. 2B is a cross-sectional view of the flow cell according to the present invention;

FIG. 3 is a cross-sectional view of a cooling block mounted on a flow cell according to the present invention;

FIG. 4A is a solid model of a conical jacket for the introduction of a secondary sheath flow around the dispensing nozzle according to the present invention;

FIG. 4B is a cross-sectional view of the conical secondary sheath jacket according to the present invention;

FIG. 5A is a 25-micron trace of particle-free silver ink on glass;

FIG. 5B is line drawing of 25-micron trace of FIG. 5A;

FIG. 5C is a 15-micron trace of particle-free silver ink on polycarbonate;

FIG. 5D is a line drawing of 15-micron trace of FIG. 5C;

FIG. 6 shows aerosol-laden carrier gas flow through an aerosol tube, and through a series of aerodynamic lenses that focus a distribution of droplet diameters according to the present invention;

FIG. 7 shows a detachable secondary flow cell 250 is attached to the flow cell housing according to the present invention;

FIG. 8 shows flow of the sheath gas through the upper section of the flow cell according to the present invention; and

FIGS. 9A and 9B are perspective and partial transparent front views of sheath inserts alone (FIG. 9A) and in the context of the aerosol tube assembly (FIG. 9B).

### DETAILED DESCRIPTION OF THE INVENTION

The present invention has utility in aerosol-based printing to deposit fine and ultrafine traces on a substrate. Fine traces are defined as traces with line width between 15 and 50 microns. Ultrafine traces are defined as traces with line width less than 15 microns.

It is to be understood that in instances where a range of values are provided, for example with respect to a weight percentage range of a composition component, that the range is intended to encompass not only the end point values of the range but also intermediate values of the range as explicitly being included within the range and varying by the last significant figure of the numeral. By way of example, a recited range of from 1 to 4 is intended to include 1-2, 1-3, 2-4, 3-4, and 1-4.

The present invention will now be described with reference to the following embodiments. As is apparent by these descriptions, this invention can be embodied in different forms and should not be construed as limited to the embodiments set forth herein. For example, features illustrated with respect to one embodiment can be incorporated into other embodiments, and features illustrated with respect to a particular embodiment can be deleted from that embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

The current invention uses ultrasonic aerosolization to produce an aerosol from a bulk liquid. In a common use of ultrasonic aerosolization, a 1.6 MHz transducer produces droplets with a median diameter of approximately 3 microns. However, droplets with diameters as small as approximately 0.3 and as large as 5 microns are produced using a 1.6 MHz transducer, so that a multi-lens aerodynamic focusing assembly generally is needed to perform high-definition printing. The current invention modifies the droplet distribution to match the range of droplet diameters to at least one aerodynamic lens or an assembly of lenses designed for high-definition aerosol printing.

The present invention uses a cooler and water pump to reduce the ink temperature in the printer to below approximately 30 °C and in other embodiments to between 5 and 15 °C. Reduction of the ink temperature produces at least three significant effects, which are; (1) a shift in the droplet diameter distribution towards larger sizes, (2) a reduction in ink solvent evaporation, and (3) an increase in the droplet viscosity. It is appreciated that a compressor circulating a refrigerant or heat transfer fluid are also operative herein as coolers. It is further appreciated two or more coolers, of like or variable types are used to create a staged cooling of the ink and the resulting aerosol.

Management of surface energies is a critical aspect of printing hyperfine traces. In general, all printing techniques require a balance between the ink surface tension and the substrate surface energy. If the ink surface tension is too large with respect to the substrate surface energy, dewetting of the substrate will occur, leading to poor line quality and poor adhesion. Conversely, if the ink surface tension is too low with respect to the substrate energy, uncontrolled ink spreading will occur, disabling the printing process. Current aerosol printing processes and apparatuses reported in the public domain improve surface wetting and adhesion and prevent uncontrolled ink spreading by heating the substrate to temperatures as high a 100 °C. However, in the case of high-definition printing of traces of approximately 50 microns or less, substrate heating can produce severe overspray due to heating and convective flow of air around the deposition zone. Contrastingly, the current invention overcomes the problem of uncontrolled ink spreading and poor surface adhesion by cooling the aerosol droplets to significantly increase the ink surface tension. The resulting print is gradually heated to the required processing temperature of the ink.

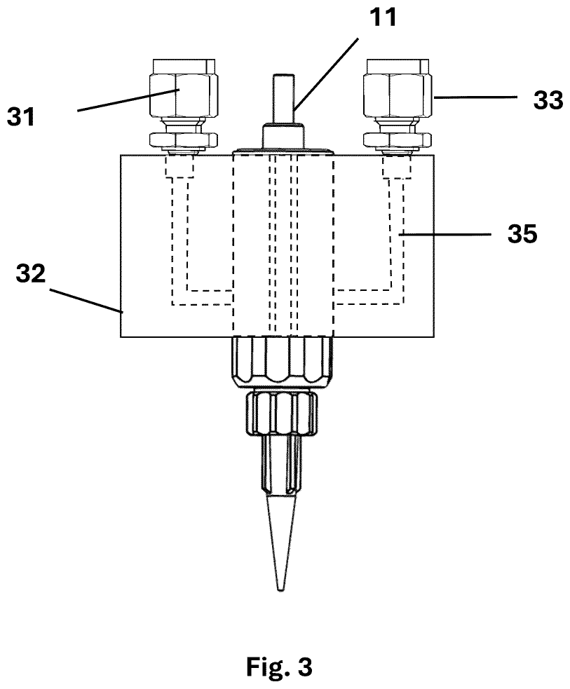

An embodiment of the current invention is shown in FIG. 3. In the embodiment of FIG. 3, a water-cooled sleeve is fitted around the flow cell of the aerosol printer, and chilled water is used to increase the ink viscosity by cooling the aerosol stream.

The low sheath gas flow rate, and the corresponding low aerosol flow rate, allow for operation at relatively low pressures, resulting in a lower solvent dewpoint. The lower solvent dew point temperature reduces the occurrence of solvent vapor condensation inside the print head, which reduces variations in the aerosol deposition rate and reduces the occurrence of clogging.

At micron-size dimensions, perturbations of particle motion due to thermal effects can lead to defocusing of an aerosol stream, producing overspray and satellite droplet deposition. The current invention overcomes the problem associated with surface thermal effects by cooling the substrate to 5 to 15 °C below the ambient temperature.

In yet another embodiment of the invention, a secondary sheath gas is used to form a jacketed flow around the dispense nozzle. The jacket gas forms a collimated flow that helps to maintain the aerosol jet gas velocity for as much as a centimeter from the dispense nozzle orifice. The sheath jacket therefore extends the working distance of the printer and minimizes or eliminates perturbations of the aerosol jet caused by ambient air currents. The jacket flow may also eliminate asymmetric printing caused by circulating air flow moving up from a heated substrate.

In another embodiment of the invention, the sheath gas is cooled before being introduced into the print head. In such a manner, components of the print head that are upstream of the sheath introduction point can be maintained at a higher temperature than the target sheath gas temperature to reduce or eliminate vapor condensation. In such a configuration, the sheath gas is cooled to a level where aerosol cooling in the printer flow cell is sufficient to significantly increase the viscosity of the ink aerosol droplets.

In some inventive embodiments, a cooled substrate platen supports the printing substrate, and is cooled below the freezing point of an ink or below the freezing point of a component of an ink. Cooling the substrate below the freezing point of an ink or of a component of an ink enables pinning of coalesced droplets on the substrate surface, allowing for increased fluid stacking.

In another embodiment of the invention, ink is deposited on a substrate with the temperature of the ink near its freezing point, and with the substrate below the ink freezing point. In a post-deposition processing step, the frozen ink is placed under vacuum, and the solvent is removed from the deposited structure, going directly from solid to vapor in a sublimation process.

In some inventive embodiments, ink deposition produced in the processes of the invention may also be processed using rapid post processing techniques that use pulsed energy systems such as Q-switched lasers or a broad-spectrum pulsed light source like a flashlamp.

The larger droplet diameter distribution reduces the production of overspray deposition created by small unfocused or poorly focused droplets that follow the gas streamlines as the aerosol jet impacts the substrate. Lowering the ink temperature also improves ink stability by reducing ink solvent evaporation; particularly in the case of volatile ink compositions such as alcohol-based formulations. Reduced solvent evaporation also helps to maintain the droplet diameter distribution and prevents the distribution from shifting to smaller diameters. Lastly, reduced ink temperature increases the droplet surface tension and viscosity and allows for increased ink pinning and stacking at the substrate. The increased stacking enables printed trace heights as large as 10 microns per pass.

### Increased Process Stability

The ultrasonic aerosolization process of the invention imparts heat to the ink, so that ink cooling is critical to reducing thermal ink degradation, and to promoting process stability. Furthermore, in the case of nanoparticle inks, nanoparticles will tend to agglomerate and fall out of suspension when heated. However, cooling reduces ink degradation during printing and produces a highly stable process, capable of more than twenty-four hours of continuous operation without user intervention.

### Narrowing the Droplet Diameter Distribution

In preferred embodiment of the invention, an aerosol-laden carrier gas flows along an inclined channel, from an aerosol chamber to a flow cell. The distance the aerosol-laden gas travels along the incline before entering an inclined channel is approximately 1 cm. The angle of the inclination is variable between 0 and 30 degrees from vertical. However, the low aerosol flow rates of the high-definition printing process (often less than 1 ccm) significantly increase the droplet residence time in the inclined channel, leading to increased droplet settling. The effect of droplet settling is to remove the largest droplets (diameters of approximately 2 to 5 microns) from the droplet diameter distribution. The inclination of the channel allows accumulated fluid to flow back into the aerosol chamber.

### Aerodynamic and Hydrodynamic Focusing of a Narrow Droplet Distribution

The narrowed droplet distribution produced by cooled ink and droplet settling is delivered to the printer flow cell using a carrier gas. At the flow cell the aerosol stream is combined with a co-flowing sheath gas that forms an annular configuration, consisting of an inner aerosol-laden carrier gas and a cylindrically symmetric outer sheath gas. The combined flow is then propagated through a series of one or more aerodynamic lenses and a final dispense nozzle. The presence of the sheath gas reduces the effective diameter of the aerodynamic lenses and nozzle, so that ultrafine traces can be printed on various substrates. The narrowed droplet diameter distribution can be more effectively focused over the operational range of at least one aerodynamic lens, improving the trace edge definition and helping to eliminate extraneous droplet deposition outside the target deposition zone.

### Increased Droplet Residence Time and Droplet Filtering

The increased droplet residence time produced by flow through the inclined channel and the low carrier gas flow rates lead to droplet filtering through aerosol settling. Indeed, the apparatus of the invention will filter large droplets, removing droplets in the range of approximately 2 to 5 microns from the carrier gas. The settled droplets impact the bottom of an inclined transport channel, flow backwards against the carrier gas flow, and return to the ink vial.

The droplet diameter distribution is therefore truncated at the smaller diameters by the decreased ink temperature and truncated at the larger diameters by droplet settling, significantly narrowing the droplet distribution.

### Single-Lens Apparatus

The most common embodiment of the invention uses a series of aerodynamic lenses to focus a distribution of aerosol droplet diameters. However, if the diameter distribution is sufficiently narrow, a single-lens system, consisting of a dispense nozzle or a capillary, may be used to focus an aerosol stream and deposit traces as small as approximately one micron.

### High-Accuracy Mass Flow Control

High-definition trace printing is enabled in part by using high-accuracy mass flow controllers (MFC's) to transport and focus the aerosol. The present invention therefore uses MFC's with a minimum flow rate accuracy of 0.1 sccm. The precision of high-accuracy MFC's allow for printing of traces as small as 1 micron, without trace necking or bulging.

### Increased Droplet Viscosity at the Substrate Surface—Cooled Flow Cell

Management of surface energies is a critical aspect of printing hyperfine traces. In general, all printing techniques require a balance between the ink surface tension and the substrate surface energy. If the ink surface tension is too large with respect to the substrate surface energy, dewetting of the substrate will occur, leading to poor line quality and poor adhesion. Conversely, if the ink surface tension is too low with respect to the substrate energy, uncontrolled ink spreading will occur, disabling the printing process. Current aerosol printing processes and apparatuses reported in the public domain improve surface wetting and adhesion and prevent uncontrolled ink spreading by heating the substrate to temperatures as high a 100 °C. However, in the case of high-definition printing of traces of approximately 50 microns or less, substrate heating can produce severe overspray due to heating and convective flow of air around the deposition zone. The current invention overcomes the problem of uncontrolled ink spreading and poor surface adhesion by cooling the aerosol droplets to significantly increase the ink surface tension. The resulting print is gradually heated to the required processing temperature of the ink.

An embodiment of the current invention is shown in FIG. 3. In the embodiment of FIG. 3, a water-cooled sleeve is fitted around the flow cell of the aerosol printer, and chilled water is used to increase the ink viscosity by cooling the aerosol stream.

### Lower Solvent Dew Point, Reduced Condensation, and Reduced Clogging

The low sheath gas flow rate, and the corresponding low aerosol flow rate, allow for operation at relatively low pressures, resulting in a lower solvent dewpoint. The lower solvent dew point temperature reduces the occurrence of solvent vapor condensation inside the print head, which reduces variations in the aerosol deposition rate and reduces the occurrence of clogging.

### Substrate Cooling

At micron-size dimensions, perturbations of particle motion due to thermal effects can lead to defocusing of an aerosol stream, producing overspray and satellite droplet deposition. The current invention overcomes the problem associated with surface thermal effects by cooling the substrate to 5 to 25 °C below the ambient temperature.

### Secondary Sheath Flow

In yet another embodiment of the invention, a secondary sheath gas is used to form a jacketed flow around the dispense nozzle. The jacket gas forms a collimated flow that helps to maintain the aerosol jet gas velocity for as much as a centimeter from the dispense nozzle orifice. The sheath jacket therefore extends the working distance of the printer and minimizes or eliminates perturbations of the aerosol jet caused by ambient air currents. The jacket flow may also eliminate asymmetric printing caused by circulating air flow moving up from a heated substrate.

### Sheath Gas Cooling

In another embodiment of the invention, the sheath gas is cooled before being introduced into the print head. In such a manner, components of the print head that are upstream of the sheath introduction point can be maintained at a higher temperature than the target sheath gas temperature to reduce or eliminate vapor condensation. In such a configuration, the sheath gas is cooled to a level where aerosol cooling in the printer flow cell is sufficient to significantly increase the viscosity of the ink aerosol droplets.

### Sub-Freezing Substrate Temperature

The invention may also use a cooled substrate platen, wherein a substrate is cooled below the freezing point of an ink or below the freezing point of a component of an ink. Cooling the substrate below the freezing point of an ink or of a component of an ink enables pinning of coalesced droplets on the substrate surface, allowing for increased fluid stacking.

Sublimation Post Processing

In another embodiment of the invention, ink is deposited on a substrate with the temperature of the ink near its freezing point, and with the substrate below the ink freezing point. In a post-deposition processing step, the frozen ink is placed under vacuum, and the solvent is removed from the deposited structure, going directly from solid to vapor in a sublimation process.

### Rapid Post Processing

The deposition produced in the processes of the invention may also be processed using rapid post processing techniques that use pulsed energy systems such as Q-switched lasers or a broad-spectrum pulsed light source like a flashlamp.

### Directed Energy Processing

Continuous laser energy or another focused directed energy source may be used to process ink deposited onto the substrate.

### Heated Solvent Vapor-Laden Carrier Gas

The present invention also produces high-definition traces using an apparatus where a heated carrier gas is propagated through a volume above an ink solvent reservoir and flowed through an aerosol chamber. The aerosol chamber is maintained at a lower temperature than the heated vapor-laden carrier gas. As the carrier gas flows through the aerosol chamber, the colder aerosol droplets become condensation nuclei, and solvent vapor condenses onto the droplets. The diameter distribution of the aerosol droplets can therefore be shifted to larger values, removing smaller droplets that are difficult to focus, or that follow the gas streamlines at the substrate, producing overspray deposition.

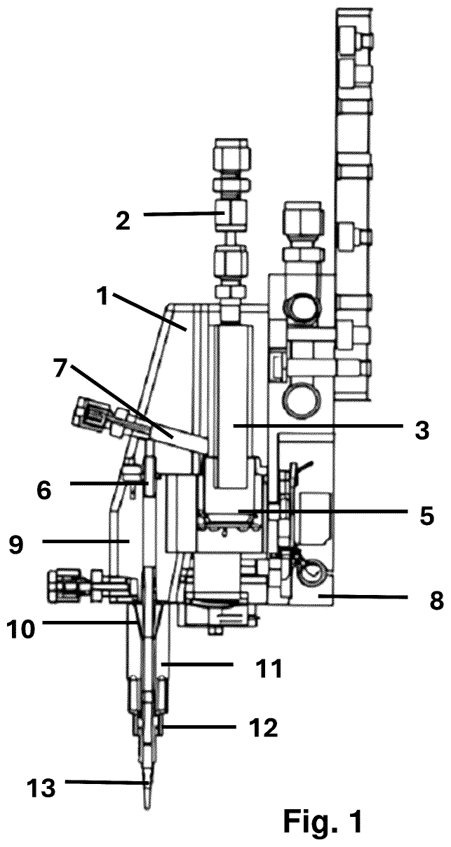

A common embodiment of the invention is shown in FIG. 1. An interchangeable ink cartridge 1 is used to position an ink volume above a nebulizer assembly, and to aerosolize and transport ink droplets to a flow cell 11. Ink is placed in a detachable vial 5 that screws into the bottom of the cartridge. The cartridge 1 is cooled by a cold plate 8 attached to an atomizer base 9. A thin membrane forms the bottom of the vial and allows for the transmission of ultrasonic energy from the nebulizer's ultrasonic transducer and into the ink. The ink is aerosolized and entrained in a carrier gas that flows into cartridge 1 through the input gas fitting 2. An aerosol-laden carrier gas flows through an inclined channel 7 and is delivered to the flow cell 11. A baffle 3 protects the input and output ports of the cartridge from the liquid ultrasonic spout produced by the aerosolization (nebulization) process. The low gas flow rates of the process produce gravitational droplet settling in the inclined channel 7, so that large droplets fall out of suspension, flow backwards along the channel, and are returned to the vial 5. The cooled ink shifts the droplet distribution to larger droplet sizes, while the slanted channel removes the largest droplets through gravitational settling.

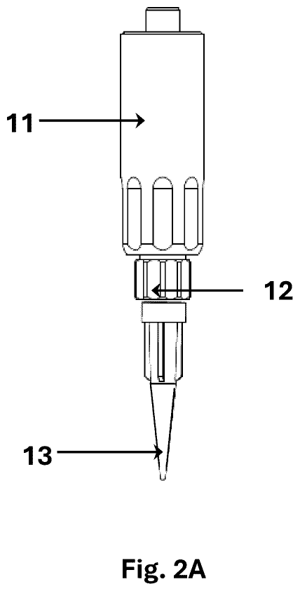

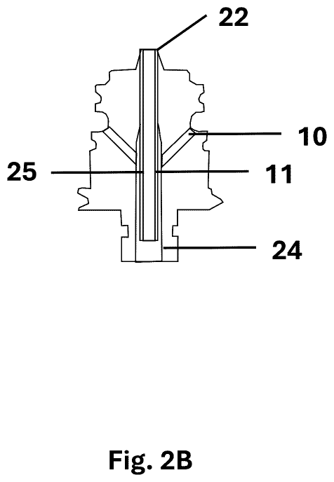

FIG. 2A shows the flow cell 11 of the invention, where the aerosol and sheath flows are combined. FIG. 2B is a cross-sectional view of the flow cell 11 and shows the slanted sheath channels 10 and the internal flow axis channel 25. The flows exit the flow cell at threaded port 24. The sheath flow enters the flow cell at the top of the unit, through slanted channels 10. The slanted sheath gas channels 10 terminate near the bottom of the flow cell. The aerosol flow enters the flow cell through the aerosol tube 22, and flows along the flow cell axis 25 until being combined with the sheath flow. Referring to FIG. 2A, the combined flows then propagate through a first aerodynamic lens 12, continue along the flow axis and are then propagated through a dispense nozzle 13.

FIG. 3 shows the preferred embodiment of the invention. A cooling block 35 is fitted over the printer flow cell 11. Chilled water is circulated through channel 32 via liquid input and output ports 31 and 33, so that aerosol propagating through the flow cell 11 is cooled to between 0 and 10 °C. The reduced ink droplet temperature may significantly increase the droplet surface tension, so that pinning of ink to the substrate is facilitated. Ink pinning is critical for the deposition process not to undergo uncontrolled spreading, and for printing of high-aspect ratio structures. The increased ink droplet surface tension also facilitates printing of high-resolution traces with sub-micron edge definition.

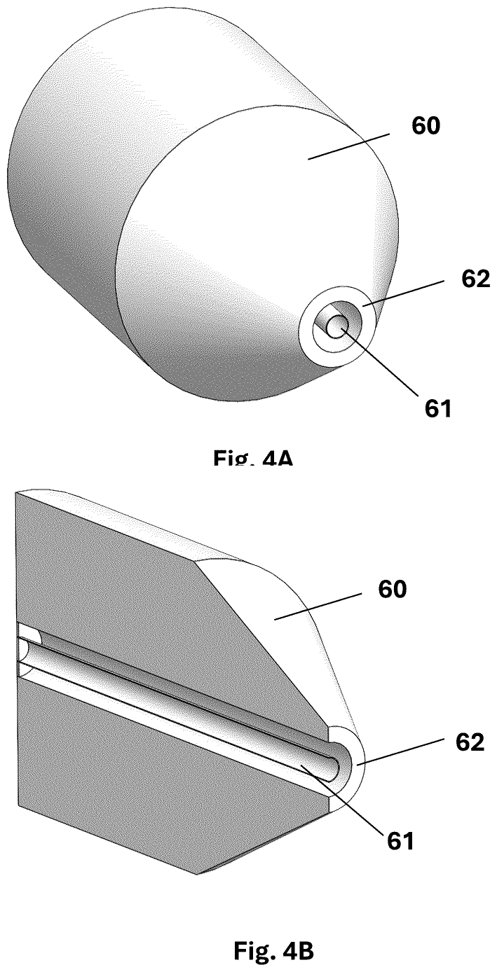

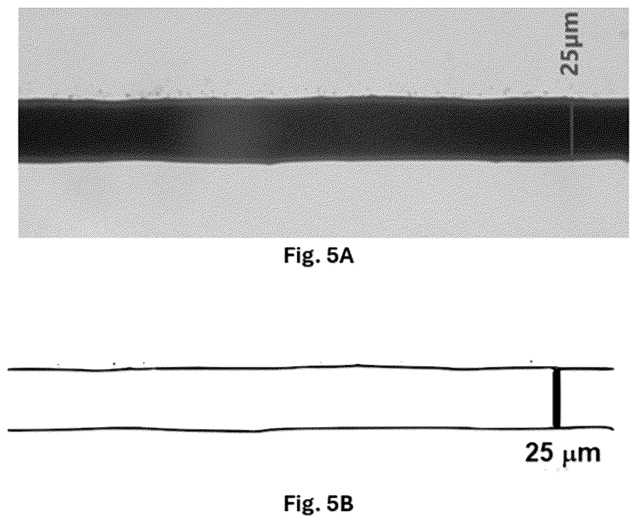

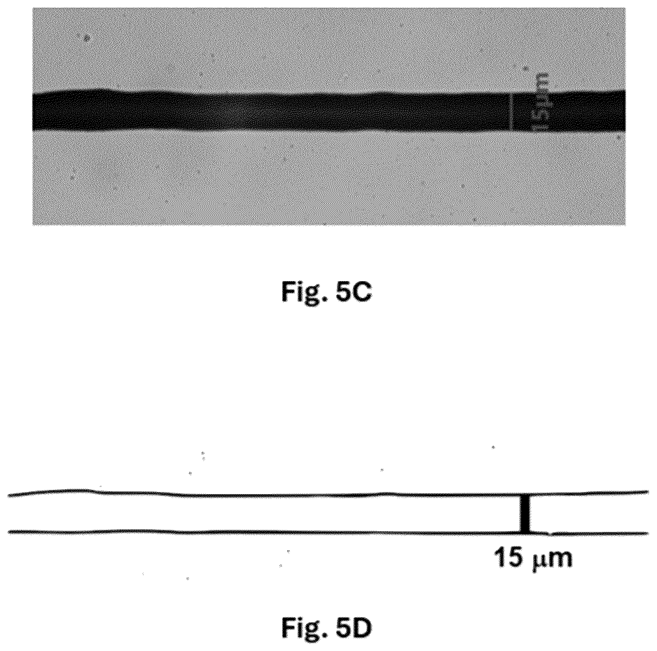

In still another embodiment, a jacketed flow is produced wherein the annular jet described in the previous embodiments is surrounded by a second sheath flow. The secondary sheath maintains the jet velocity as the aerosol stream flows away from the exit orifice, increasing the printer working distance, and shielding the jet from random perturbations caused by air flowing past the dispense tip. The attachment used to form the jacket flow is shown in FIGS. 4A and 4B. In the jacket flow configuration, a hypodermic needle 61 is used as the dispense nozzle, and a housing 60 is fitted around the needle, so that an annular flow is established along the needle. The jacket flow is combined with the primary sheath and aerosol flows at the nozzle exit 62. FIG. 5A and FIG. 5B show a micrograph and an associated line image of a 25-micron silver ink trace deposited on glass. FIG. 5C and FIG. 5D show a micrograph and an associated line image of a 15-micron silver ink trace deposited on glass. FIG. 5E and FIG. 5F show a micrograph and an associated line image of a 10-micron silver ink trace deposited on glass.

Another embodiment of the present invention uses aerodynamic and hydrodynamic processes that use independently developed aerosol and sheath gas flows to form a highly focused inner aerosol-laden flow surrounded by an annular particle-free sheath gas flow. Initially the two flows propagate separately along the axis of a flow cell, and different configurations are used to develop laminar flow in each case. In the case of the inner aerosol flow, aerosol droplets are focused using a long aerosol tube with multiple embedded aerodynamic lenses. The aerosol tube is surrounded by the sheath flow that forms a highly cylindrically symmetric distribution that propagates along the outside of the aerosol tube, independent of the aerosol-laden gas flow. The two flows are combined and injected into a converging nozzle after an aerosol droplet distribution has been focused by at least one aerodynamic lens. In the current invention both aerosol and sheath flows form highly developed cylindrically symmetric laminar flows along the axis of the flow cell before being combined in a plenum above a dispense nozzle.

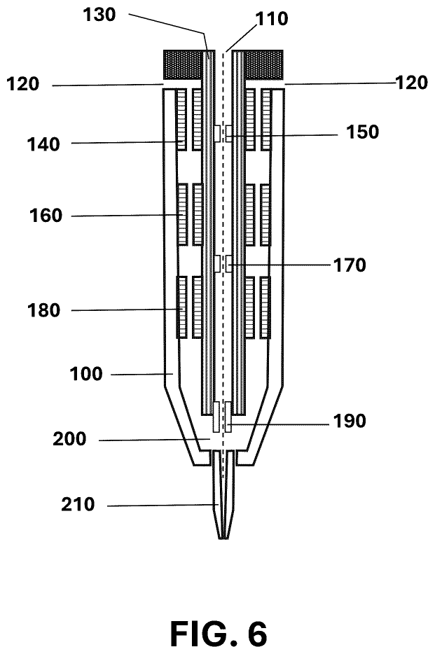

Referring to FIG. 6 an aerosol-laden carrier gas flow is directed through an aerosol tube 130, and through a series of aerodynamic lenses that focus a distribution of droplet diameters. In some inventive embodiments, the first aerodynamic lens 150 has the largest orifice diameter and focuses large droplets in the aerosol droplet distribution compared to downstream lenses. The second and third lenses, 170 and 190, focus the medium and small droplet diameters, respectively. The sheath inserts and aerodynamic lenses are assembled in a flow cell housing 100. In some inventive embodiments that cross-sectional ratio of orifice diameters for lenses 150:170:190 ranges from 1:0.4-1:0.1-0.7 and in still other inventive embodiments, the orifice area decreases 150>170>190.

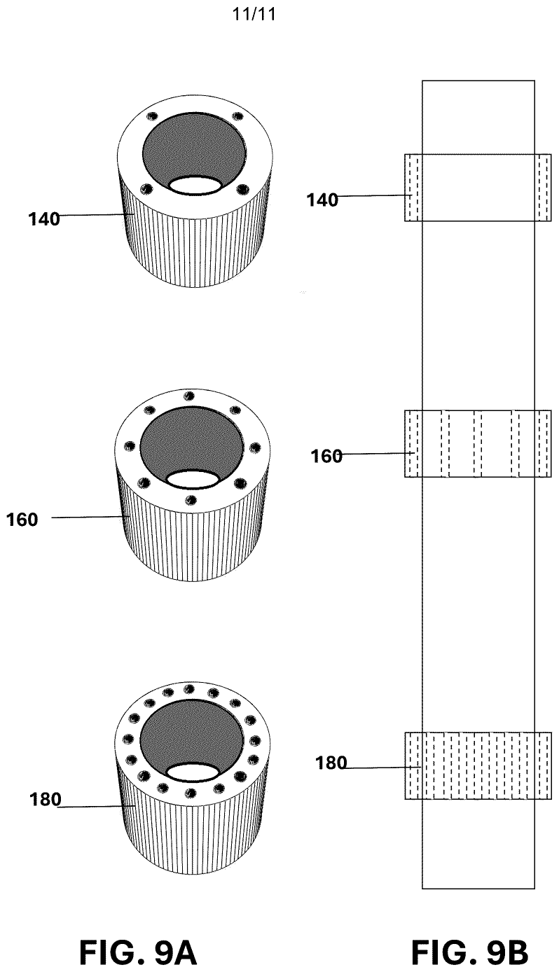

In the case of the sheath flow, sheath gas streams are introduced at sheath entry ports 120. For the purposes of illustration two sheath gas substreams are shown; however, it is appreciated that the sheath gas streams can be split into other numbers of substreams, such as three, four, or more substreams. In some inventive embodiments, the substreams are within 20 mass flow percent of equal to one another. In still other embodiments, the substreams are within 10 mass flow percent of equal to one another. As best seen in FIGS. 9A and 9B, the substreams flow are divided and flow through four inclined channels machined into the first sheath insert 140. The angle of the inclination is variable between 0 and 30 degrees from vertical. The four flows emerge from sheath insert 140, are each split, and propagate into eight inclined channels machined in the second sheath insert 160. The angle of the inclination in insert 160 is variable between 0 and 30 degrees from vertical. Each flow stream from sheath insert 160 is then split and flows into sixteen inclined channels machined in the third sheath insert 180. The angle of the inclination in the third insert 180 is variable between 0 and 30 degrees from vertical. While three such inserts are shown in the figures, it is appreciated that two inserts that have an aspect ratio at least 10% longer than those depicted are also functional herein, or alternatively four, five, or even six such inserts are readily used herein with the general characteristic that the area of the vertical channels increases as the inserts progress downstream relative to the sheath gas flow. The configuration of FIG. 6 therefore produces a highly developed highly cylindrically symmetric pressure distribution that is combined with the highly focused aerosol stream at plenum 200. It is appreciated that number of vertical channels in each insert 140, 160, and 180 are not limited to the 4-8-16 progression shown, and instead the cross-sectional area of three inserts as shown typically has an area ratio 140:160:180 of 1:1.1-3.8:3:8-10. The combined flow is then injected into converging nozzle 210. The diameter of the sheath insert channels can range from approximately 500 microns to 3 millimeters.

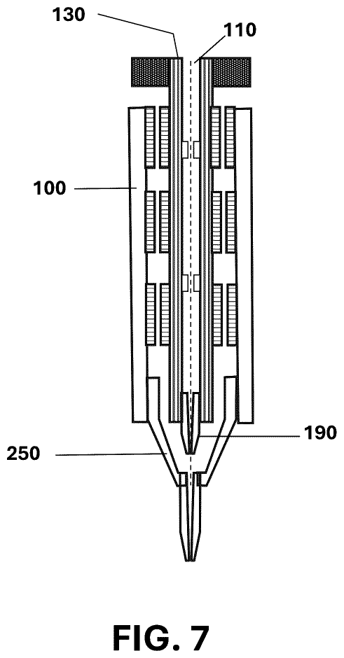

Another embodiment of the present invention is shown in FIG. 7. In the configuration of FIG. 7, a detachable secondary flow cell 250 is attached to the flow cell housing 100. A detachable converging nozzle 210 is connected to the exit of the secondary flow cell. The secondary flow cell facilitates access to the primary flow cell for replacement of the aerosol tube and aerosol inserts.

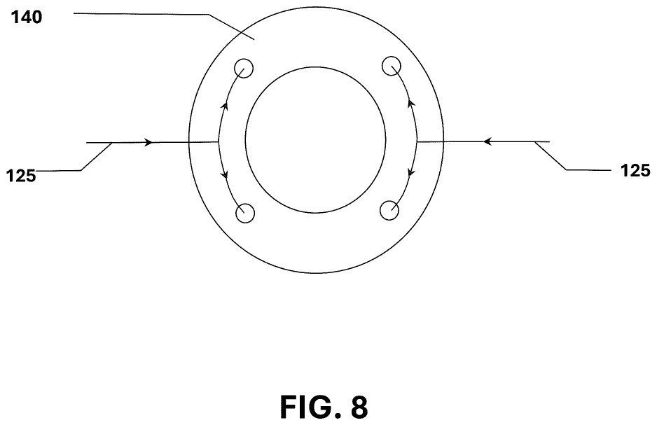

Flow of the sheath gas through the upper section of the flow cell is depicted in FIG. 8. Two substantially equal gas flows 125 enter the flow cell at sheath input ports 120, shown in FIG. 6. Since the flow paths presented to each flow have equal resistance, the two flows are each equally divided into flows that propagate horizontally and enter the vertical channels of sheath insert 140. The sheath insert and aerosol tube assembly is shown in FIGS. 9A and 9B. The configuration of FIGS. 9A and 9B therefore splits the two initial sheath substreams as shown into four vertically propagating flows that then enter sheath insert 160, where the number of vertical flow channels is doubled to eight and then to sixteen by sheath insert 180. The configuration produces sixteen laminar streams that flow along the outside of the flow tube, forming a cylindrically symmetric pressure distribution that forms a cylindrically symmetric annular sheath around the aerosol flow when the sheath and aerosol flows are combined.

The configuration of FIG. 6 is capable of producing high-definition print features with widths ranging from one micron to 1 millimeter. The print features are readily produced continuously for from 4 to 24 hours provided ink is supplied and the temperature thereof maintained.

### REFERENCES CITED

Brockmann, J. E., et. al., Aerodynamic Beam Generator for Large Particles. U.S. Pat. No. 6,348,687, Feb. 19, 2002.
Cheng and Dahneke. (1979). Properties of Continuum Source Particle Beams. II. Beams Generated in Capillary Expansions. J. Aerosol Sci., 10, 363-368.
Dahneke. (1977). Nozzle-Inlet Design For Aerosol Beam Instruments. In J. J. Potter, Rarefied Gas Dynamics, Vol. II (pp. 1163-1172). New York: AIAA.
Dahneke. (1978). Aerosol Beams. In D. T. Shaw, Recent Developments in Aerosol Science (pp. 187-223). New York: John Wiley & Sons.
Dahneke. (1979). Properties of Continuum Source Particle Beams. I. Calculation Methods and Results. J. Aerosol Sci., 10, 257-274.
De la Mora. (1988). Aerodynamic Focusing of Particles in a Carrier Gas. J. Fluid Mech., 195, 121.
Deng, R. (2008). Focusing Particles with Diameters of 1 to 10 Microns into Beams at Atmospheric Pressure. Aerosol Science and Technology, 42:11, 899-915.
Hochberg, F., et. al. Micromist Jet Printer. U.S. Pat. No. 4,019,188, Apr. 19, 1977.
Lee, D., Lee, K., Aerodynamic Lens Capable of Focusing Nanoparticles in a Wide Range, U.S. Pat. No. 8,119,977 B2 , Feb. 21, 2012.
Lee, D., and Lee, K., Aerodynamic Lens, U.S. Pat. No. 7,652,247 B2 , Jan. 26, 2010.
Mallina. (1999). High-Speed Particle Beam Generation: Simple Focusing Mechanisms. J. Aerosol Sci., 30, 719-738.
Mallina. (2000). High Speed Particle Beam Generation: a Dynamic Focusing Mechanism for Selecting Ultrafine Particles. Aerosol Sci. Technol., 33, 87-104.
Novosselov, et. al., Particle interrogation devices and methods, U.S. Pat. No. 8,561,486, Oct. 22, 2013.
Rao, N.P., et. al., Apparatus and Method for Synthesizing Films and Coatings by Focused Particle Beam Deposition, U.S. Pat. No. 6,924,004 B2 , Aug. 2, 2005.

Patents and publications mention the specification are indicative of the levels of those skilled in the art to which the invention pertains. These patents and publications are incorporated herein by reference to the same extent as if each individual patent or publication was specifically and individually incorporated herein by reference.

The forgoing description is illustrative of particular embodiments of the invention, but is not meant to be a limitation upon the practice thereof. The following claims, including all equivalents thereof are intended to define the scope of the invention.

What is claimed:

1. An apparatus for stable aerosol-based printing features on a surface, the apparatus comprising:
an aerosolization source adapted to produce an aerosol from an ink;
a cooler that cools at least one of the ink or the substrate to a temperature between 0 and 30 °C;
an ink cartridge retaining the ink and having an inclined channel;
a compressed gas source adapted to transport the aerosol;
at least one aerodynamic lens adapted to have a lens gas sheath around the aerosol transiting therethrough; and
a dispense nozzle or a capillary adapted to have a dispense gas sheath around the aerosol and focusing the aerosol to a minimum deposited size of 1 micron or less.

2. The apparatus of claim 1 wherein the apparatus is capable of uninterrupted purge-free printing of 1-micron traces with 2-micron spacing for 24 hours or more.

3. The apparatus of claim 1 further comprising a second cooler adapted to cool the aerosol to a temperature between approximately 5 and 25 °C and at least one of the first.

4. The apparatus of claim 1 wherein the inclined channel is horizontal.

5. The apparatus of claim 1 further comprising an aerosol chamber in fluid communication with the ink cartridge.

6. The apparatus of claim 1 further comprising at least two successive sheath gas inserts each having a plurality of orifices adapted to divide the lens gas sheath gas into substreams.

7. The apparatus of claim 6 wherein the least two sheath gas inserts increase in total area of the plurality of orifices from the first sheath gas insert to the second sheath gas insert.

8. The apparatus of claim 6 wherein the least two sheath gas inserts are three inserts that have a total orifice area ratio of 1:1.1-3.8:3:8-10.

9. The apparatus of claim 6 wherein the plurality of orifices are inclined at an of between 0 and 30 degrees from vertical.

10. The apparatus of claim 1 wherein at least one aerodynamic lens is an assembly of two or three lenses.

11. The apparatus of claim 10 wherein the two or three lenses decrease in aperture area successively downstream relative to the aerosol flow.

12. A process capable of printing 1-micron traces with 2-micron spacing for 24 hours comprising:
producing an aerosol distribution with initial droplet diameters ranging from approximately 0.3 to 5 microns; and
using an ultrasonic aerosolization excitation frequency in the range of 0.1 to 1.0 MHz.

13. The process of claim 12 further comprising ink cooling and gravitational settling to narrow the said droplet distribution to a range of approximately 0.3 to 2 microns.

14. A process of operating an apparatus of claim 1 wherein with traces width as small as 1 micron and as large as 1 millimeter, with spacing as small of 1 micron.

15. The process of claim 14 wherein the multi-stage aerodynamic lens assembly narrows an aerosol droplet diameter distribution in the aerosol.

16. The process of claim 14 wherein the dispense nozzle or a capillary produces droplet settling and narrows the droplet diameter distribution of the aerosol.

17. The process of claim 14 wherein a heated vapor-laden carrier gas is propagated through an aerosol chamber and condensed onto droplets of the aerosol, shifting an aerosol droplet diameter distribution to larger sizes.

18. The process of claim 14 wherein the sheathed gas flow is cooled below ambient temperature to cool the aerosol as the aerosol travels to the substrate.

19. The process of claim 14 wherein the substrate temperature is cooled below the freezing point of the ink.

20. The process of claim 14 further comprising introducing an additional jacket flow to surround the aerosol and protect the aerosol from ambient air currents as the aerosol travels to the substrate.
